(19) United States
(12) Patent Application Publication
(10) Pub. No.: US 2026/0119928 A1
(43) Pub. Date: Apr. 30, 2026

(54) MAPPING TO QUANTUM BACKEND TOPOLOGIES

(71) Applicant: International Business Machines Corporation, Armonk, NY (US)

(72) Inventors: Filippo Utro, Pleasantville, NY (US); Laxmi Parida, Mohegan Lake, NY (US); Aritra Bose, Astoria, NY (US)

(21) Appl. No.: 18/922,672

(22) Filed: Oct. 22, 2024

(51) Int. Cl. G06N 10/20; G06F 16/901

(52) U.S. Cl. CPC G06N 10/20; G06F 16/9024

(57) ABSTRACT

Systems and techniques that facilitate mapping of data graphs to quantum computer backend topologies are provided. For example, one or more embodiments described herein can comprise a system, which can comprise a memory that can store computer executable components. The system can also comprise a processor, operably coupled to the memory that can execute the computer executable components stored in memory. The computer executable components can comprise a mapping component that maps a data graph to a lattice structure of the quantum computer, wherein the mapping comprises: mapping a graph node of the data graph to a lattice node of the lattice structure; and mapping the immediate descendant nodes and grand-descendant nodes of the graph node to nodes of the lattice structure based on relative number of edges of the immediate descendant nodes and grand-descendant nodes and the nodes of the lattice structure.

### BACKGROUND

The subject disclosure relates to operation of quantum computers, and more specifically, to mapping of data graphs to quantum computer backend topologies.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate mapping of data graphs to quantum computer backend topologies.

According to an embodiment, a system can comprise: a memory that stores computer executable components; and a processor that executes the computer executable components stored in the memory, wherein the computer executable components comprise: a mapping component that maps a data graph to a lattice structure of the quantum computer, wherein the mapping comprises: mapping a graph node of the data graph to a lattice node of the lattice structure; and mapping the immediate descendant nodes and grand-descendant nodes of the graph node to nodes of the lattice structure based on relative number of edges of the immediate descendant nodes and grand-descendant nodes and the nodes of the lattice structure. An advantage of such a system is that it enables mapping of a higher percentage of edges of the data graph, thereby more accurately capturing the interactivity between nodes of the data graph.

In one or more embodiments, the mapping can further comprise selecting the graph node from the data graph based on number of edges of nodes in the data graph and selecting the lattice node from the lattice structure based on number of edges of nodes in the lattice structure. An advantage of such a system is that the node of the data graph with the most edges can be mapped to the node (e.g., qubit) of the lattice structure with the highest number of possible connections, thereby enabling mapping of a greater percentage of edges of the graph node.

According to another embodiment, a computer-implemented method can comprise mapping, by a device operatively coupled to a processor, a data graph to a lattice structure of a quantum computer, wherein the mapping comprises: mapping, by the device, a graph node of the data graph to a lattice node of the lattice structure; and mapping, by the device, the immediate descendant nodes and grand-descendant nodes of the graph node to nodes of the lattice structure based on relative number of edges of the immediate descendant nodes and grand-descendant nodes and the nodes of the lattice structure. An advantage of such a computer-implemented method is that it enables mapping of a higher percentage of edges of the data graph, thereby more accurately capturing the interactivity between nodes of the data graph.

In one or more embodiments, the mapping can further comprise selecting the graph node from the data graph based on number of edges of nodes in the data graph and selecting the lattice node from the lattice structure based on number of edges of nodes in the lattice structure. An advantage of such a system is that the node of the data graph with the most edges can be mapped to the node (e.g., qubit) of the lattice structure with the highest number of possible connections, thereby enabling mapping of a greater percentage of edges of the graph node.

According to another embodiment, a computer program product can comprise a computer readable storage medium having program instructions embodied therewith, the program instructions executable by a processor to cause the processor to map, by the processor, a data graph to a lattice structure of a quantum computer, wherein the mapping comprises: mapping a graph node of the data graph to a lattice node of the lattice structure; and mapping the immediate descendant nodes and grand-descendant nodes of the graph node to nodes of the lattice structure based on relative number of edges of the immediate descendant nodes and grand-descendant nodes and the nodes of the lattice structure. An advantage of such a computer program product is that it enables mapping of a higher percentage of edges of the data graph, thereby more accurately capturing the interactivity between nodes of the data graph.

In one or more embodiments, the mapping can further comprise selecting the graph node from the data graph based on number of edges of nodes in the data graph and selecting the lattice node from the lattice structure based on number of edges of nodes in the lattice structure. An advantage of such a system is that the node of the data graph with the most edges can be mapped to the node (e.g., qubit) of the lattice structure with the highest number of possible connections, thereby enabling mapping of a greater percentage of edges of the graph node.

### DESCRIPTION OF THE DRAWINGS

FIG. 1 illustrates a block diagram of an example, non-limiting, system that can map data graphs to backend topologies of quantum computers in accordance with one or more embodiments described herein.

FIG. 2 illustrates an example of a non-limiting data graph in accordance with one or more embodiments described herein.

FIG. 3 illustrates an example of a mapping of a data graph onto the backend topology of a quantum computer in accordance with one or more embodiments described herein.

FIG. 4 illustrates a comparison of the mapping approach presented herein and an existing approach at mapping a random graph shown in accordance with one or more embodiments described herein.

FIG. 5 illustrates a comparison of the mapping approach presented herein and an existing approach at mapping a Barabasi Albert graph shown in accordance with one or more embodiments described herein.

FIG. 6 illustrates a comparison of the mapping approach presented herein and an existing approach at mapping a Barbell graph shown in accordance with one or more embodiments described herein.

FIG. 7 illustrates a comparison of the mapping approach presented herein and an existing approach at mapping a DepMap Sparse graph shown in accordance with one or more embodiments described herein.

FIG. 8 illustrates a comparison of the mapping approach presented herein and an existing approach at mapping a Karate Club graph shown in accordance with one or more embodiments described herein.

FIG. 9 illustrates a comparison of the mapping approach presented herein and an existing approach at mapping a second random graph shown in accordance with one or more embodiments described herein.

FIG. 10 illustrates a comparison of the mapping approach presented herein and an existing approach at mapping a third random graph shown in accordance with one or more embodiments described herein.

FIG. 11 illustrates a comparison of the mapping approach presented herein and an existing approach at mapping a Hex lattice graph shown in accordance with one or more embodiments described herein.

FIG. 12 illustrates a graph comparing the performance of the mapping approach described herein and an existing mapping approach in accordance with one or more embodiments described herein.

FIG. 13 illustrates a flow diagram of an example, non-limiting, computer implemented method that facilitates mapping of data graphs onto quantum computer backend topologies in accordance with one or more embodiments described herein.

FIG. 14 illustrates an algorithm for selecting mapping candidates in accordance with one or more embodiments described herein.

FIG. 15 illustrates a block diagram of an example, non-limiting system that can complete the execution of a quantum job in accordance with one or more embodiments described herein.

FIG. 16 illustrates an example, a non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As referenced herein, an “entity” can comprise a client, a user, a computing device, a software application, an agent, a machine learning (ML) model, an artificial intelligence (AI) model, and/or another entity.

Within quantum computing, qubits of the quantum computer are arranged within a lattice structure, with connections between various qubits. In order to execute data operations on a quantum computer, the problem must be mapped to these qubits. Often, data problems can be described as a graph with a series of nodes and edges connecting the nodes. However, mapping these data graphs to the backend topology of the quantum computer (e.g., the lattice structure of qubits within the quantum computer) can often be challenging as the lattice structure may differ greatly from that of the graph and may be unable to accommodate all nodes and edges of the graph. This creates the need for the ability to map as much of the data graph as possible to the lattice structure, necessitating decisions between which node and edges should be mapped and which should not. While existing mapping techniques exist, they focus on prioritizing nodes over edges. These mappings fail to capture the interconnectivity within the data graphs. This makes them unsuitable for use in quantum computing, as without the edges there is no connectivity between the nodes, limiting the usefulness of quantum operations executed on the mapping.

In view of the problems discussed above, the present disclosure can be implemented to produce a solution to one or more of these problems by mapping a data graph to a lattice structure of a quantum computer, wherein the mapping comprises executing a breadth first search starting from a lattice node in the lattice structure, executing a depth first search starting from a graph node of the data graph, sorting immediate descendant nodes of the graph node (alternatively referred to as child nodes) by degrees (e.g., the number of edges connecting to a node), mapping the graph node to the lattice node and mapping the immediate descendant nodes and grand-descendant nodes (e.g., immediate descendant nodes of the immediate descendant nodes) of the graph node to nodes of the lattice structure based on relative degrees of the immediate descendant nodes and grand-descendant nodes and the degrees of the nodes of the lattice structure. In this manner, the mapping process can prioritize mapping nodes with higher degrees (number of edge connections), which then increases the total number of nodes mapped as the edges are followed to find the next nodes of the graph to map to the lattice structure. Accordingly, the method and systems described herein can improve the performance of quantum computing by improving the coverage of data graph mappings, and thus the complexity of the problems executed by the quantum computer.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

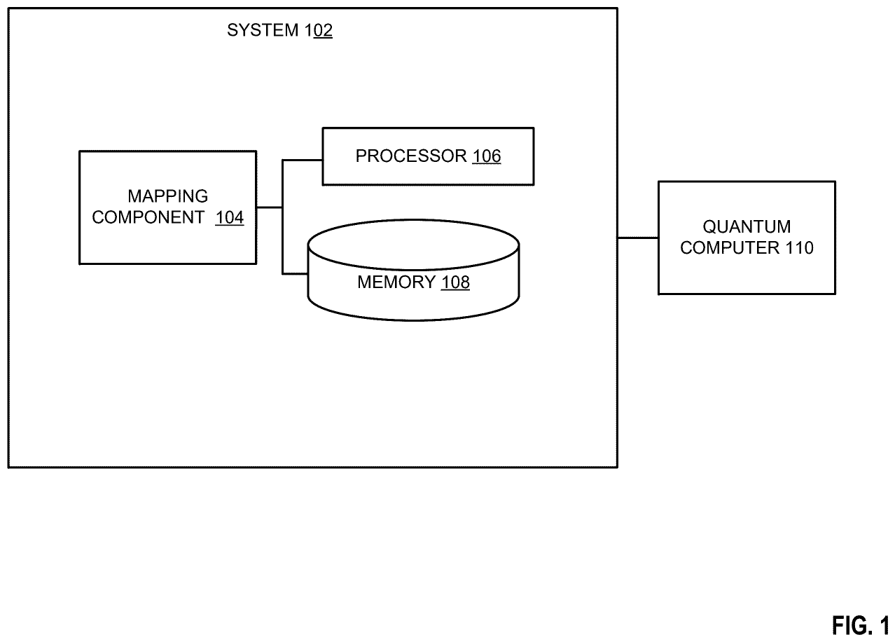

FIG. 1 illustrates a block diagram of an example, non-limiting system 102 that can facilitate mapping of problems represented as data graphs to backend topologies of quantum computers in accordance with one or more embodiments described herein. Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise mapping component 104, processor 106 and memory 108. In addition to the elements described in relation to system 102, system 102 can be coupled to quantum computer 110.

In various embodiments, system 102 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the system 102 (e.g., mapping component 104) to perform one or more acts. In various embodiments, memory 108 can store computer-executable components (e.g., mapping component 104) and processor 106 can execute the computer-executable components.

In one or more embodiments, mapping component 104 can map a data graph to a lattice structure of quantum computer 110. For example, mapping component 104 can receive a data problem for execution on quantum computer 110 in the form of a data graph. The goal of mapping component 104 is to find a mapping of the data graph onto a backend topology (e.g., a lattice structure of qubits) of a quantum computer, wherein nodes of the data graph are mapped to qubits of the topology and the edges are mapped to the connections between the qubits. Accordingly, the more nodes and edges that can be mapped to the topology will produce a more accurate mapping and thus a more accurate result when operations are performed on the qubits.

To achieve a mapping that balances the mapping of nodes and edges, mapping component 104 can first compute the degrees (e.g., the number of edges connecting to) nodes within both the data graph and a graph representing the lattice structure of the backend topology. This can be performed through the use of a graph parsing algorithm that parses the whole of a graph and records the number of nodes and associated edges within the graph. Mapping component 104 can then select a starting data node from the data graph based on the number of edges (e.g., degrees) of the node. Mapping component 104 can then select a starting node of the lattice structure. In one or more embodiments, mapping component 104 can select the starting lattice node based on various criteria such as the node with the highest number of degrees, the node's relative position to the center of the lattice structure, or the quality/capabilities of the qubits within the lattice structure. Each of these options provides various benefits. For example, by selecting a lattice node with the highest number of connections/edges, it is possible to more closely capture the edges of the starting graph node. By selecting a lattice node closest to the center of the lattice structure, there is a greater chance that edges of nodes further down the data graph will be able to be mapped. Selecting the qubit with the best hardware/performance capabilities provides benefits during execution of the data graph as the starting node is likely to be involved with the most operations.

Once a starting node of the data graph and a starting node of the lattice structure have been selected, a breath first search can be executed starting from the starting node of the lattice structure and a depth first search can be executed starting from the starting node of the data graph in order to determine parent immediate descendant node relations in both the data graph and lattice structure graph. Mapping component 104 can then sort the immediate descendant nodes of the starting data graph node by degree. Once they are sorted, mapping component 104 can map the starting data graph node to the starting lattice node. Mapping component 104 can then map the immediate descendant and grand-descendant nodes of the starting data graph node to nodes of the lattice structure based on relative degrees of the immediate descendant nodes, the grand-descendant nodes and the nodes of the lattice structure. For example, for i∈min(degree(Sₕ, S_{g}) wherein Sₕ is the starting lattice node and wherein S_{g} is the starting data graph node, mapping component 104 can map S_{g} to Sₕ, map the immediate descendant and grand-descendant (e.g., immediate descendant nodes of immediate descendant nodes) of S_{g} to immediate descendant and grand-descendant nodes of Sₕ based on the relative degrees, and mark all the mapped nodes in the graph as marked. For each node mapped, mapping component can return to the breadth first and depth first search process and repeat the mapping process until all nodes within the data graph are mapped, all nodes within the lattice structure are mapped, there are no more possible mappings, or until an elapsed mapping time has passed. Once the mapping has been completed, quantum computer 110 can begin execution of operations on the mapped data graph. In this manner, mapping component 104 can prioritize mapping of graphs nodes to lattice structures with a similar number of edges/possible qubit connections, thereby allowing for a mapping with a greater number of mapped edges.

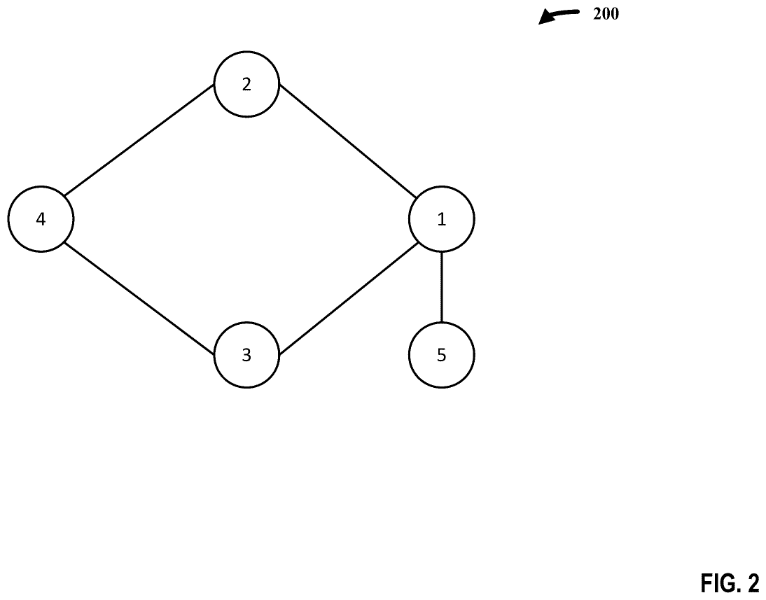

FIG. 2 illustrates an example of a non-limiting data graph 200 in accordance with one or more embodiments described herein.

As described above, a data graph can be used to represent problems and/or systems with nodes representing states or subcomponents of the problem and edges denoting connections or causality between nodes of the graph. As shown, data graph 200 comprises node 1-5, wherein node 1 has edges to nodes 2, 3 and 5, node 2 has edges to nodes 1 and 4, node 3 has edges to nodes 1 and 4, node 4 has edges to nodes 2 and 3, and node 5 has an edge to node 1.Accordingly, when sorted by degrees, node 1 has a degree of three, nodes 2-4 have a degree of two and node 5 has a degree of one.

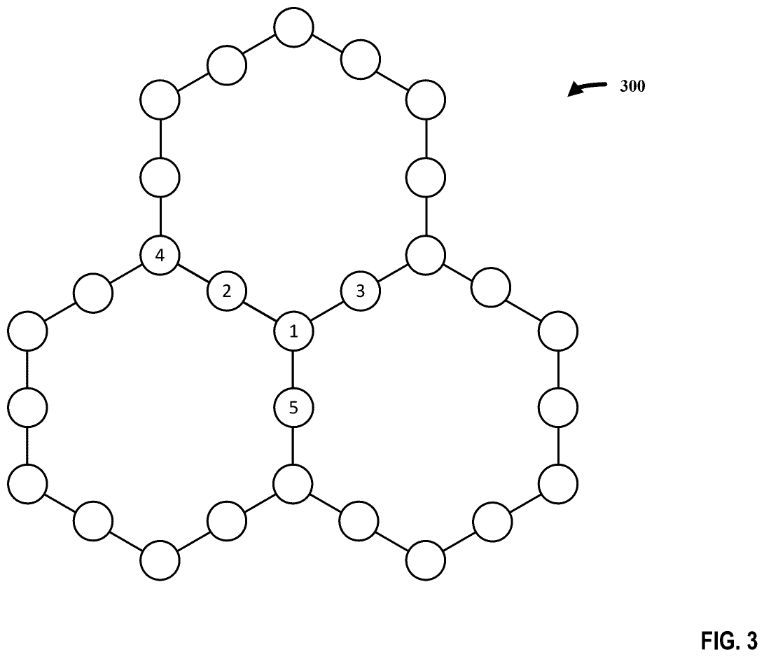

FIG. 3 illustrates an example of a mapping of a data graph onto the backend topology of a quantum computer in accordance with one or more embodiments described herein.

As shown the backend topology is a heavy-hex lattice comprising three hexagonal rings of qubits connected to one another. It should be appreciated that while the example in FIG. 3 utilizes this heavy-hex format, the use of backend topologies of other formats or lattice structures is envisioned. In order to map data graph 200 onto lattice structure 300, mapping component can execute the steps described above in relation to FIG. 1. For example, mapping component 104 can identify a starting node of data graph 200 based on the relative number of degrees. Accordingly, node 1 is selected as the data graph starting node as it has highest number of degrees, three. The starting node of lattice structure 300 can also be selected as the node with the highest degree or possible number of connections, again three. However, there are multiple qubits within lattice structure 300 that can have three possible connections. Accordingly, mapping component 104 can further select the starting lattice node based on relative center to the lattice structure. Therefore, node 1 of the data graph has been mapped to the center qubit/node of lattice structure 300 as it has a high number of possible degrees and is at the center of the lattice structure. Mapping component 104 can then proceed mapping through data graph 200 as described above in relation to FIG. 1. As shown in FIG. 3, the mapping was completed when all nodes were mapped to the lattice structure, however, it was not possible to map all the edges, such as the edge between nodes 3 and 4.

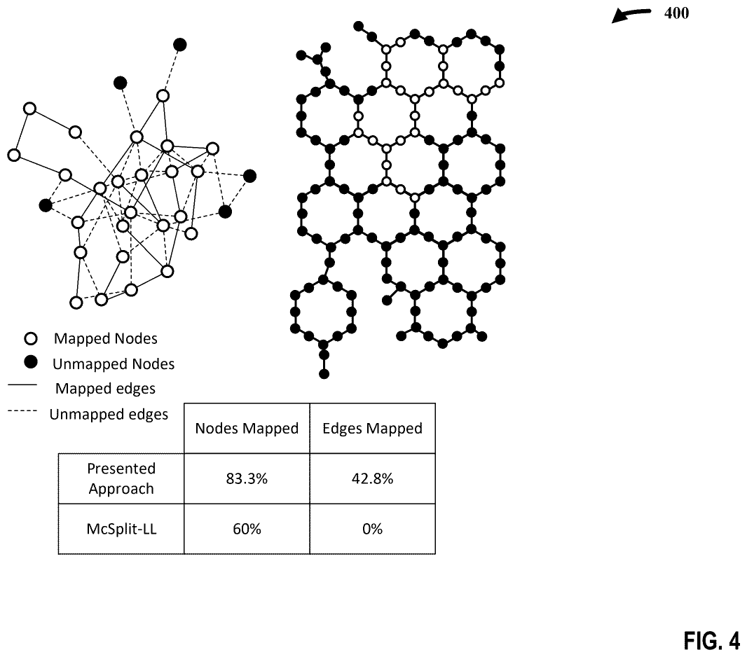

FIGS. 4-11 illustrate comparisons of the mapping process described herein and an existing McSplit-LL mapping approach in accordance with one or more embodiments described herein.

FIG. 4 illustrates a comparison of the approach presented herein and an existing McSplit-LL approach at mapping the random graph shown in FIG. 4 onto a lattice structure. As shown, the approach described herein improves both the total percentage of nodes of the data graph that are mapped, and more significantly, maps over 40% of the edges of the data graph while the existing approach fails to map any edges.

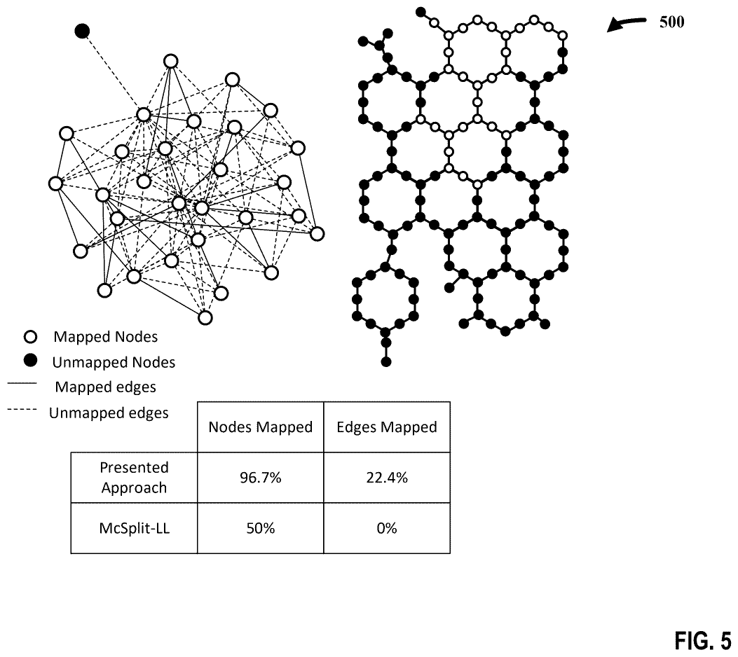

FIG. 5 illustrates a comparison of the approach presented herein and an existing McSplit-LL approach at mapping the Barabasi Albert graph shown in FIG. 5 onto a lattice structure. As shown, the approach described herein improves both the total percentage of nodes of the data graph that are mapped, and more significantly, maps over 20% of the edges of the data graph while the existing approach fails to map any edges.

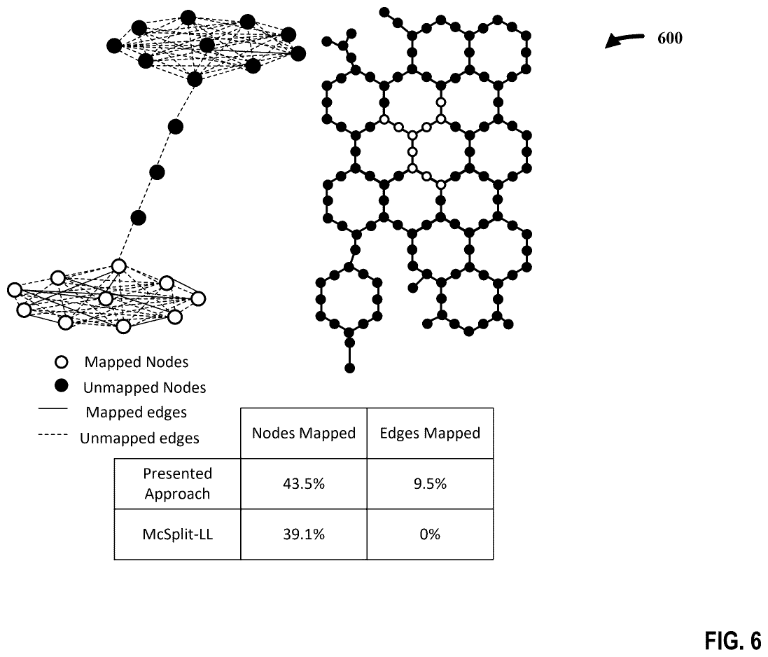

FIG. 6 illustrates a comparison of the approach presented herein and an existing McSplit-LL approach at mapping the Barbell graph shown in FIG. 6 onto a lattice structure. As shown, the approach described herein improves both the total percentage of nodes of the data graph that are mapped, and more significantly, maps 9.5% of the edges of the data graph while the existing approach fails to map any edges.

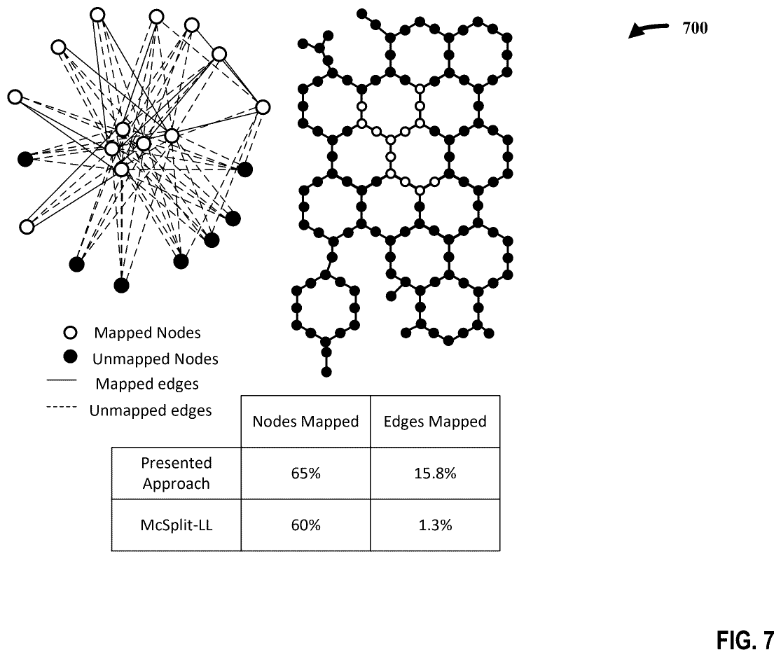

FIG. 7 illustrates a comparison of the approach presented herein and an existing McSplit-LL approach at mapping the DepMap Sparse graph shown in FIG. 7 onto a lattice structure. As shown, the approach described herein improves both the total percentage of nodes of the data graph that are mapped, and more significantly, maps 15.8 % of the edges of the data graph while the existing approach maps less than 2% of the edges.

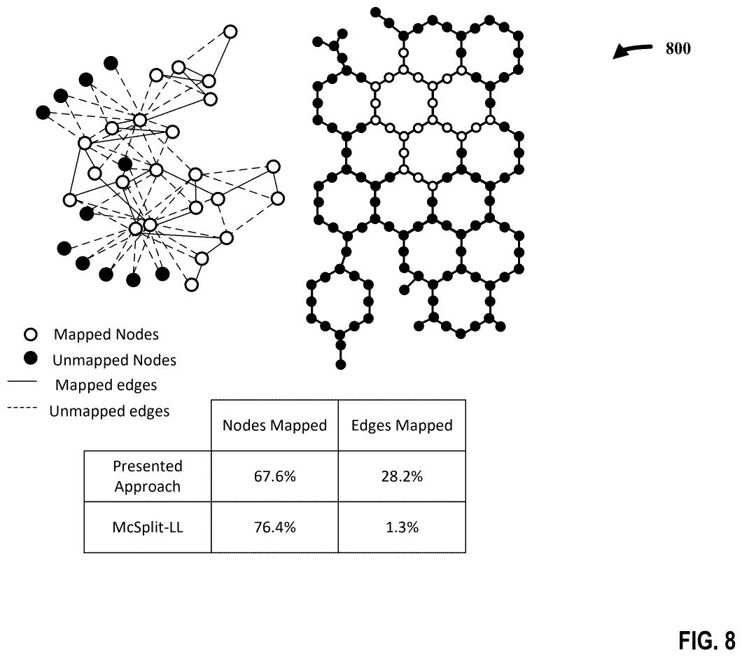

FIG. 8 illustrates a comparison of the approach presented herein and an existing McSplit-LL approach at mapping the Karate Club graph shown in FIG. 8 onto a lattice structure. As shown, the approach described herein has a sligh decrease in the total percentage of nodes of the data graph that are mapped but provides a significant improvement in the percentage of edges that are mapped.

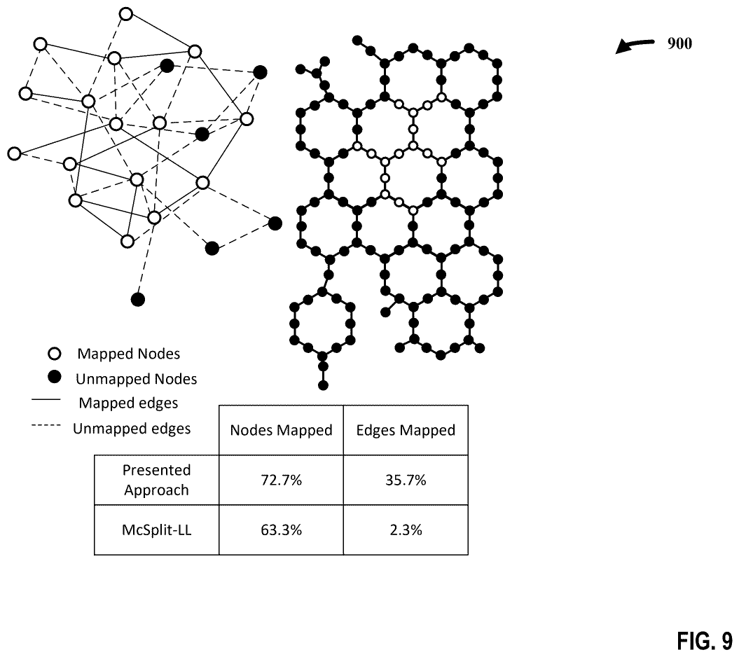

FIG. 9 illustrates a comparison of the approach presented herein and an existing McSplit-LL approach at mapping the random graph shown in FIG. 9 onto a lattice structure. As shown, the approach described herein improves both the total percentage of nodes of the data graph that are mapped, and more significantly, maps 35.7% of the edges of the data graph while the existing approach maps less than 3% of the edges.

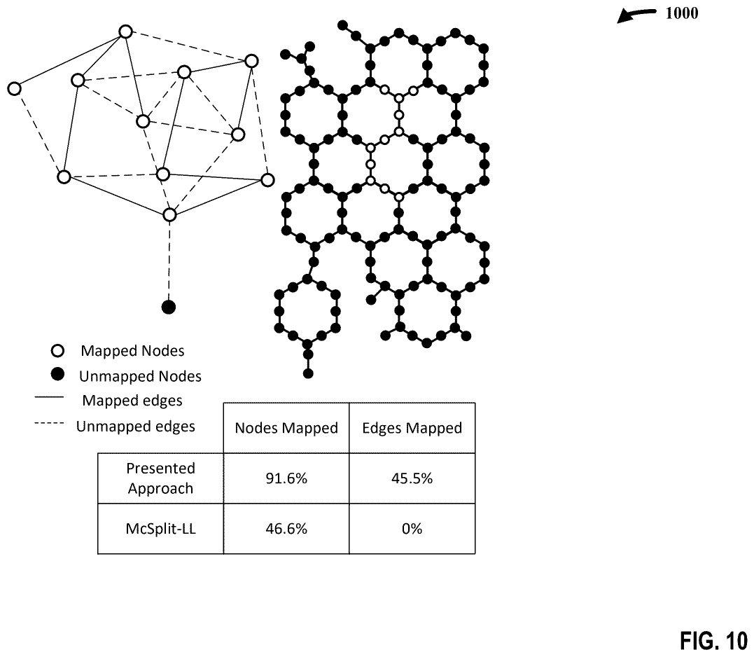

FIG. 10 illustrates a comparison of the approach presented herein and an existing McSplit-LL approach at mapping the random graph shown in FIG. 10 onto a lattice structure. As shown, the approach described herein improves both the total percentage of nodes of the data graph that are mapped, and more significantly, maps 45.5% of the edges of the data graph while the existing approach fails to map any of the edges.

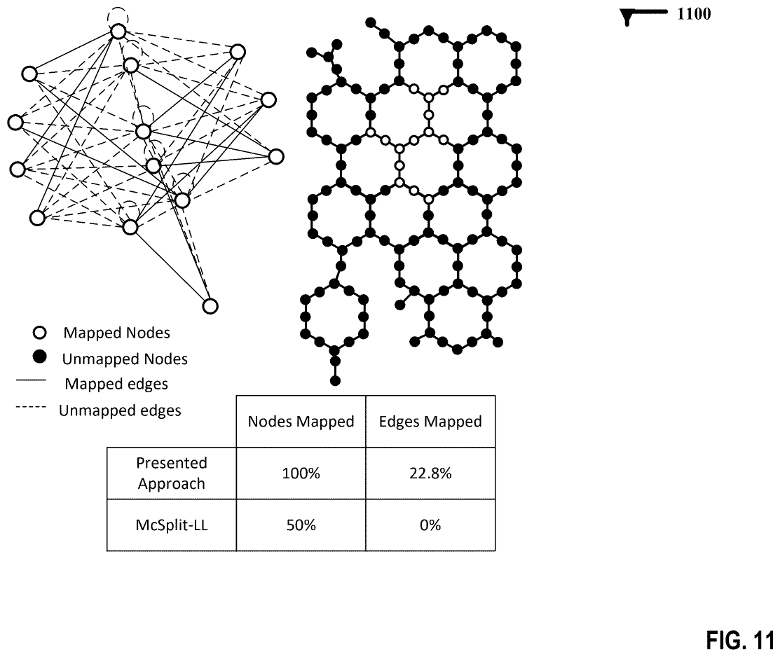

FIG. 11 illustrates a comparison of the approach presented herein and an existing McSplit-LL approach at mapping the Hex lattice graph shown in FIG. 11 onto a lattice structure. As shown, the approach described herein improves both the total percentage of nodes of the data graph that are mapped, and more significantly, maps 22.8 % of the edges of the data graph while the existing approach fails to map any of the edges.

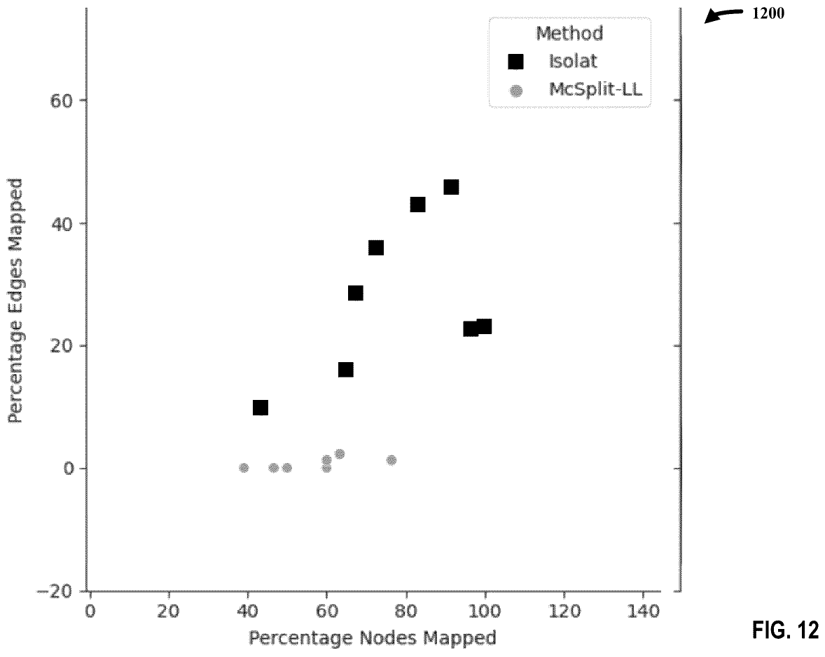

FIG. 12 illustrates a graph 1200 comparing the performance of the mapping approach described herein (listed as Isolat) and an existing McSplit-LL mapping approach on a repository of DepMap graphs in accordance with one or more embodiments described herein.

The y-axis of graph 1200 illustrates the percentage of edges of a data graph that are successfully mapped, and the x-axis illustrates the percentage of nodes that are successfully mapped. As shown, the existing approach fails to effectively map edges in any significant amounts, thereby limiting the usefulness of such mappings. In contrast, the approach provided for herein offers a significant improvement in the percentage of edges mapped, thereby producing mappings that better represent the connectivity of the data graph, and improving both the accuracy and usefulness of quantum computations performed on the mappings.

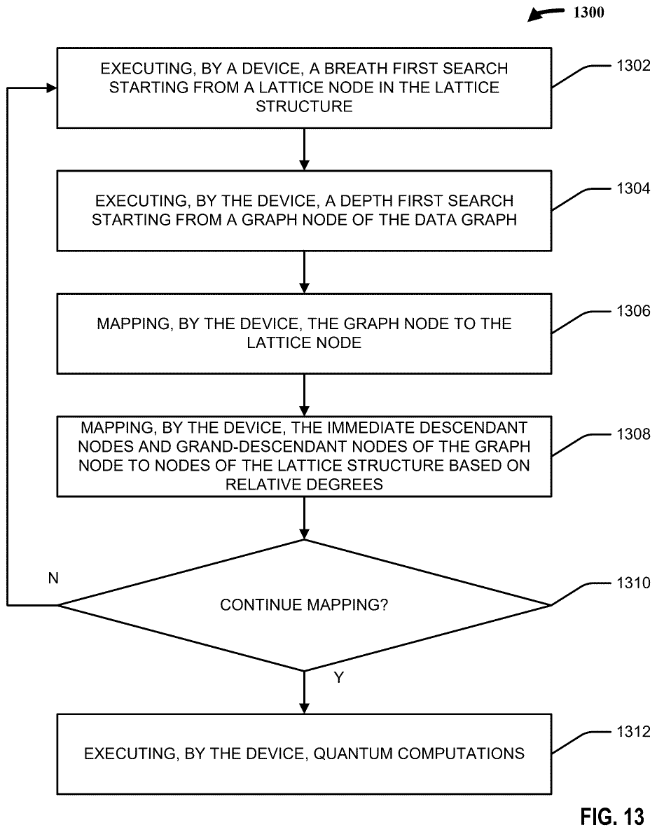

FIG. 13 illustrates a flow diagram of an example, non-limiting, computer implemented method 1300 that facilitates mapping of a data graph to a back-end topology of a quantum computer in accordance with one or more embodiments described herein.

At 1302, method 1300 can comprise executing, by a device (e.g., system 102 and/or mapping component 104) operatively coupled to a processor (e.g., processor 106), a breath first search from a starting lattice node in the lattice structure of the backend topology. As described above, the starting lattice node can be selected based on considerations such as, the node/qubit with the highest number of degrees/connections, the computational ability of the qubit, or the relative position of the node/qubit to the center of the lattice structure.

At 1304, method 1300 can comprise executing, by the device (e.g., system 102 and/or mapping component 104) a depth first search starting from a graph node of the data graph. As described above, the starting graph node can be selected as the node of the graph with the highest number of edges/degrees.

At 1306, method 1300 can comprise mapping, by the device (e.g., system 102 and/or mapping component 104) the starting graph node to the starting lattice node.

At 1308, method 1300 can comprise mapping, by the device (e.g., system 102 and/or mapping component 104), immediate descendant nodes and grand-descendant nodes of the graph node to nodes of the lattice structure based on relative number of degrees. For example, for i∈min(degree(Sₕ, S_{g}) wherein Sₕ is the starting lattice node and wherein S_{g} is the starting data graph node, mapping component 104 can map S_{g} to Sₕ, map the immediate descendant and grand-descendant (e.g., immediate descendant nodes of immediate descendant nodes) of S_{g} to immediate descendant and grand-descendant nodes of Sₕ base on the relative degrees, and mark all the mapped nodes in the graph as marked.

At 1310, method 1300 can comprise determining, by the device (e.g., system 102 and/or mapping component 104), whether to continue the mapping process. The mapping process can end when one or more mapping criteria have been met, such as an elapsed time, a specific percentage of data graph nodes or edges have been mapped, or no further mappings are possible. In response to a NO determination, method 1300 can proceed to step 1312 can quantum computations can be executed on the qubits that the data graph is mapped to. In response to a YES determination, method 1300 can return to step 1302 and use the previously mapped nodes as new starting nodes for the data graph and the lattice structure respectively.

A practical application of system 102 is the ability to more accurately map data graphs onto the lattice structures of quantum computers. As described above, existing approaches struggle especially with mapping the edges of the data graphs onto connections between qubits. This limits the usefulness of such mappings as they do not accurately capture the connectivity of the data graphs, and thus limit the usefulness of quantum computations executed on such mappings. Accordingly, by mapping a higher percentage of the edges within the data graphs, the methods and systems described herein enable more accurate and thus useful quantum computations.

It is to be appreciated that system 102 can utilize various combination of electrical components, mechanical components, and circuity that cannot be replicated in the mind of a human or performed by a human as the various operations that can be executed by system 102 and/or components thereof as described herein are operations that are greater than the capability of a human mind. For instance, the amount of data processed, the speed of processing such data, or the types of data processed by system 102 over a certain period of time can be greater, faster, or different than the amount, speed, or data type that can be processed by a human mind over the same period of time. According to several embodiments, system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that system 102 can include information that is impossible to obtain manually by an entity, such as a human user. For example, the type, amount, and/or variety of information included in system 102 can be more complex than information obtained manually by an entity, such as a human user.

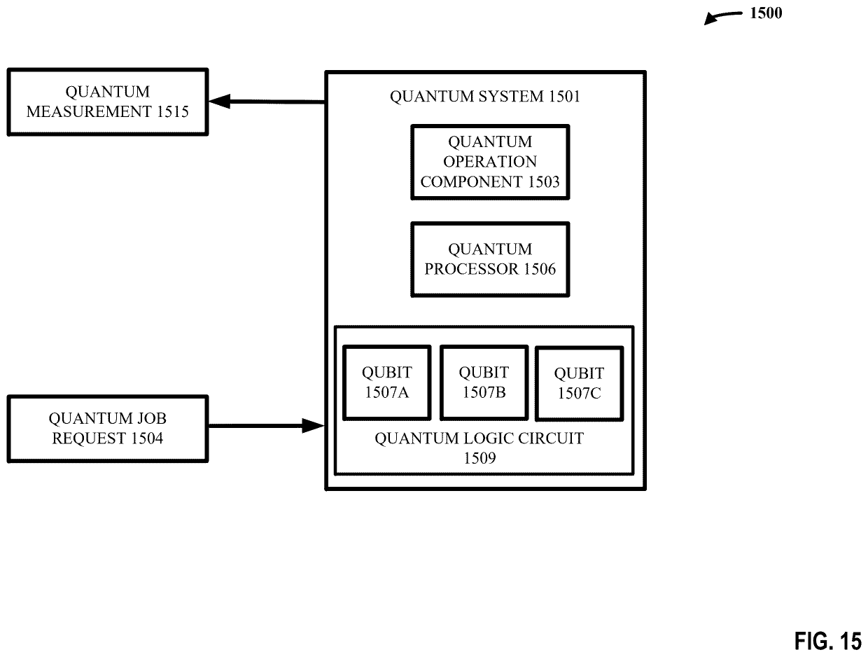

Turning generally to FIG. 15, one or more embodiments described herein (e.g., system 100) can include one or more devices, systems and/or apparatuses that can facilitate executing one or more quantum operations to facilitate output of one or more quantum results. For example, FIG. 15 illustrates a block diagram of an example, non-limiting system 1500 that can complete the execution of a quantum job.

The quantum system 1501 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), physical circuit level components, high level components and/or functions. The quantum circuity can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement 1515, can be responsive to the quantum job request 1504 and associated input data and can be based at least in part on the input data, quantum functions and/or quantum computations.

In one or more embodiments, the quantum system 1501 can comprise one or more quantum components, such as a quantum operation component 1503, a quantum processor 1506 and a quantum logic circuit 15015 comprising one or more qubits (e.g., qubits 1507A, 1507B and/or 1507C), also referred to herein as qubit devices 1507A, 1507B and 1507C. The quantum processor 1506 can be any suitable processor, capable of controlling qubit coherence and the like. The quantum processor 1506 can generate one or more instructions for controlling the one or more processes of the quantum operation component 1503.

The quantum operation component 1503 that can obtain (e.g., download, receive, search for and/or the like) a quantum job request 1504 requesting execution of one or more quantum programs. The quantum operation component 1503 can determine one or more quantum logic circuits, such as the quantum logic circuit 1509, for executing the quantum program. The request 1504 can be provided in any suitable format, such as a text format, binary format and/or another suitable format. In one or more embodiments, the request 1504 can be received by a component other than a component of the quantum system 1501, such as a by a component of a classical system coupled to and/or in communication with the quantum system 1501.

The quantum operation component 1503 can perform one or more quantum processes, calculations and/or measurements for operating one or more quantum circuits on the one or more qubits 1507A, 1507B and/or 1507C. For example, the quantum operation component 1503 can operate one or more qubit effectors, such as qubit oscillators, harmonic oscillators, pulse generators and/or the like to cause one or more pulses to stimulate and/or manipulate the state(s) of the one or more qubits 1507A, 1507B and/or 1507C comprised by the quantum system 1501. That is, the quantum operation component 1503, such as in combination with the quantum processor 1506, can execute operation of a quantum logic circuit on one or more qubits of the circuit (e.g., qubit 1507A, 1507B and/or 1507C). The quantum operation component 1503 can output one or more quantum job results, such as one or more quantum measurements 1515, in response to the quantum job request 1504.

It will be appreciated that the following description(s) refer(s) to the operation of a single quantum program from a single quantum job request. However, it also will be appreciated that one or more of the processes described herein can be scalable, such as execution of one or more quantum programs and/or quantum job requests in parallel with one another.

In one or more embodiments, the non-limiting system 1500 can be a hybrid system and thus can include both one or more classical systems, such as a quantum program implementation system, and one or more quantum systems, such as the quantum system 1501. In one or more other embodiments, the quantum system 1501 can be separate from, but function in combination with, a classical system.

In such case, one or more communications between one or more components of the non-limiting quantum system 1500 and a classical system can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

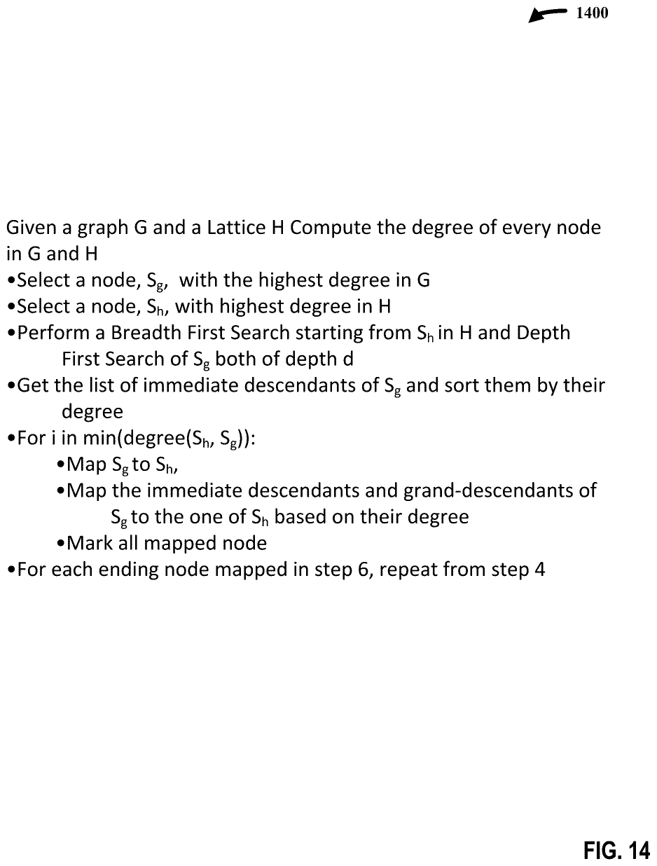

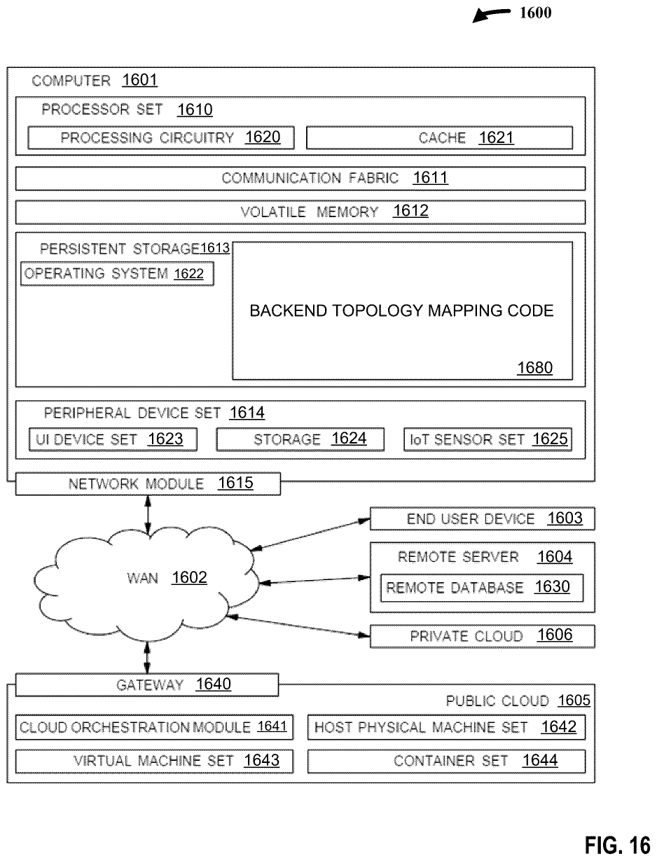

FIG. 16 and the following discussion are intended to provide a brief, general description of a suitable computing environment 1600 in which one or more embodiments described herein at FIGS. 1-14 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1600 contains an example of an environment for the execution of at least some of the computer code involved in performing the inventive methods, such as translation of an original source code based on a configuration of a target system by the summary comparison code 1680. In addition to block 1680, computing environment 1600 includes, for example, computer 1601, wide area network (WAN) 1602, end user device (EUD) 1603, remote server 1604, public cloud 1605, and private cloud 1606. In this embodiment, computer 1601 includes processor set 1610 (including processing circuitry 1620 and cache 1621), communication fabric 1611, volatile memory 1612, persistent storage 1613 (including operating system 1622 and block 1680, as identified above), peripheral device set 1614 (including user interface (UI), device set 1623, storage 1624, and Internet of Things (IoT) sensor set 1625), and network module 1615. Remote server 1604 includes remote database 1630. Public cloud 1605 includes gateway 1640, cloud orchestration module 1641, host physical machine set 1642, virtual machine set 1643, and container set 1644.

COMPUTER 1601 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1630. As is well understood in the art of computer technology, and depending upon the technology, performance of a computer-implemented method can be distributed among multiple computers and/or between multiple locations. On the other hand, in this presentation of computing environment 1600, detailed discussion is focused on a single computer, specifically computer 1601, to keep the presentation as simple as possible. Computer 1601 can be located in a cloud, even though it is not shown in a cloud in FIG. 16. On the other hand, computer 1601 is not required to be in a cloud except to any extent as can be affirmatively indicated.

PROCESSOR SET 1610 includes one, or more, computer processors of any type now known or to be developed in the future. Processing circuitry 1620 can be distributed over multiple packages, for example, multiple, coordinated integrated circuit chips. Processing circuitry 1620 can implement multiple processor threads and/or multiple processor cores. Cache 1621 is memory that is located in the processor chip package(s) and is typically used for data or code that should be available for rapid access by the threads or cores running on processor set 1610. Cache memories are typically organized into multiple levels depending upon relative proximity to the processing circuitry. Alternatively, some, or all, of the cache for the processor set can be located “off chip.” In some computing environments, processor set 1610 can be designed for working with qubits and performing quantum computing.

Computer readable program instructions are typically loaded onto computer 1601 to cause a series of operational steps to be performed by processor set 1610 of computer 1601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1621 and the other storage media discussed below. The program instructions, and associated data, are accessed by processor set 1610 to control and direct performance of the inventive methods. In computing environment 1600, at least some of the instructions for performing the inventive methods can be stored in block 1680 in persistent storage 1613.

COMMUNICATION FABRIC 1611 is the signal conduction path that allows the various components of computer 1601 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1612 is any type of volatile memory now known or to be developed in the future. Examples include dynamic type random access memory (RAM) or static type RAM. Typically, the volatile memory is characterized by random access, but this is not required unless affirmatively indicated. In computer 1601, the volatile memory 1612 is located in a single package and is internal to computer 1601, but, alternatively or additionally, the volatile memory can be distributed over multiple packages and/or located externally with respect to computer 1601.

PERSISTENT STORAGE 1613 is any form of non-volatile storage for computers that is now known or to be developed in the future. The non-volatility of this storage means that the stored data is maintained regardless of whether power is being supplied to computer 1601 and/or directly to persistent storage 1613. Persistent storage 1613 can be a read only memory (ROM), but typically at least a portion of the persistent storage allows writing of data, deletion of data and re-writing of data. Some familiar forms of persistent storage include magnetic disks and solid-state storage devices. Operating system 1622 can take several forms, such as various known proprietary operating systems or open-source Portable Operating System Interface type operating systems that employ a kernel. The code included in block 1680 typically includes at least some of the computer code involved in performing the inventive methods.

PERIPHERAL DEVICE SET 1614 includes the set of peripheral devices of computer 1601. Data communication connections between the peripheral devices and the other components of computer 1601 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1623 can include components such as a display screen, speaker, microphone, wearable devices (such as goggles and smart watches), keyboard, mouse, printer, touchpad, game controllers, and haptic devices. Storage 1624 is external storage, such as an external hard drive, or insertable storage, such as an SD card. Storage 1624 can be persistent and/or volatile. In some embodiments, storage 1624 can take the form of a quantum computing storage device for storing data in the form of qubits. In embodiments where computer 1601 is required to have a large amount of storage (for example, where computer 1601 locally stores and manages a large database) then this storage can be provided by peripheral storage devices designed for storing large amounts of data, such as a storage area network (SAN) that is shared by multiple, geographically distributed computers. IoT sensor set 1625 is made up of sensors that can be used in Internet of Things applications. For example, one sensor can be a thermometer and another sensor can be a motion detector.

NETWORK MODULE 1615 is the collection of computer software, hardware, and firmware that allows computer 1601 to communicate with other computers through WAN 1602. Network module 1615 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1615 are performed on the same physical hardware device. In other embodiments (for example, embodiments that utilize software-defined networking (SDN)), the control functions and the forwarding functions of network module 1615 are performed on physically separate devices, such that the control functions manage several different network hardware devices. Computer readable program instructions for performing the inventive methods can typically be downloaded to computer 1601 from an external computer or external storage device through a network adapter card or network interface included in network module 1615.

WAN 1602 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1603 is any computer system that is used and controlled by an end user (for example, a customer of an enterprise that operates computer 1601) and can take any of the forms discussed above in connection with computer 1601. EUD 1603 typically receives helpful and useful data from the operations of computer 1601. For example, in a hypothetical case where computer 1601 is designed to provide a recommendation to an end user, this recommendation would typically be communicated from network module 1615 of computer 1601 through WAN 1602 to EUD 1603. In this way, EUD 1603 can display, or otherwise present, the recommendation to an end user. In some embodiments, EUD 1603 can be a client device, such as thin client, heavy client, mainframe computer and/or desktop computer.

REMOTE SERVER 1604 is any computer system that serves at least some data and/or functionality to computer 1601. Remote server 1604 can be controlled and used by the same entity that operates computer 1601. Remote server 1604 represents the machine(s) that collect and store helpful and useful data for use by other computers, such as computer 1601. For example, in a hypothetical case where computer 1601 is designed and programmed to provide a recommendation based on historical data, then this historical data can be provided to computer 1601 from remote database 1630 of remote server 1604.

PUBLIC CLOUD 1605 is any computer system available for use by multiple entities that provides on-demand availability of computer system resources and/or other computer capabilities, especially data storage (cloud storage) and computing power, without direct active management by the scale. The direct and active management of the computing resources of public cloud 1605 is performed by the computer hardware and/or software of cloud orchestration module 1641. The computing resources provided by public cloud 1605 are typically implemented by virtual computing environments that run on various computers making up the computers of host physical machine set 1642, which is the universe of physical computers in and/or available to public cloud 1605. The virtual computing environments (VCEs) typically take the form of virtual machines from virtual machine set 1643 and/or containers from container set 1644. It is understood that these VCEs can be stored as images and can be transferred among and between the various physical machine hosts, either as images or after instantiation of the VCE. Cloud orchestration module 1641 manages the transfer and storage of images, deploys new instantiations of VCEs and manages active instantiations of VCE deployments. Gateway 1640 is the collection of computer software, hardware and firmware allowing public cloud 1605 to communicate through WAN 1602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1606 is similar to public cloud 1605, except that the computing resources are only available for use by a single enterprise. While private cloud 1606 is depicted as being in communication with WAN 1602, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1165 and private cloud 1166 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a memory that stores computer executable components; and
a processor that executes the computer executable components stored in the memory,
wherein the computer executable components comprise:
a mapping component that maps a data graph to a lattice structure of a quantum computer, wherein the mapping comprises:
mapping a graph node of the data graph to a lattice node of the lattice structure; and
mapping the immediate descendant nodes and grand-descendant nodes of the graph node to nodes of the lattice structure based on relative number of edges of the immediate descendant nodes and grand-descendant nodes and the nodes of the lattice structure.

2. The system of claim 1, wherein the mapping further comprises computing number of edges of nodes in the data graph and computing number of edges of nodes in the lattice structure.

3. The system of claim 2, wherein the mapping further comprises selecting the graph node from the data graph based on number of edges of nodes in the data graph and selecting the lattice node from the lattice structure based on number of edges of nodes in the lattice structure.

4. The system of claim 3, wherein the lattice node is further selected based on relative position closest to a center of the lattice structure.

5. The system of claim 1, wherein the mapping further comprises:
executing a breadth first search starting from the lattice node;
executing a depth first search starting from the graph node;
sorting immediate descendant nodes of the graph node by number of edges; and
repeating the mapping starting from mapped immediate descendant nodes and grand-descendant nodes of the graph node.

6. The system of claim 1, wherein the lattice structure comprises a heavy-hex structure.

7. A computer implemented method comprising:
mapping, by a device operatively coupled to a processor, a data graph to a lattice structure of a quantum computer, wherein the mapping comprises:
mapping, by the device, a graph node of the data graph to a lattice node of the lattice structure; and
mapping, by the device, the immediate descendant nodes and grand-descendant nodes of the graph node to nodes of the lattice structure based on relative number of edges of the immediate descendant nodes and grand-descendant nodes and the nodes of the lattice structure.

8. The computer implemented method of claim 7, further comprising:
computing, by the device, number of edges of nodes in in the data graph;
computing, by the device, number of edges of nodes in the lattice structure:
executing, by the device, a breadth first search starting from the lattice node;
executing, by the device, a depth first search starting from the graph node; and
sorting, by the device, immediate descendant nodes of the graph node by number of edges.

9. The computer implemented method of claim 8, further comprising:
selecting, by the device, the graph node from the data graph based on number of edges of nodes in the data graph.

10. The computer implemented method of claim 9, further comprising:
selecting, by the device, the lattice node from the lattice structure based on number of edges of nodes in the lattice structure.

11. The computer implemented method of claim 7, wherein the mapping further comprises, repeating, by the device, the mapping starting from mapped immediate descendant nodes and grand-descendant nodes of the graph node.

12. The computer implemented method of claim 7, wherein the lattice structure comprises a heavy-hex structure.

13. The computer implemented method of claim 10, wherein the lattice node is further selected based on relative position closest to a center of the lattice structure.

14. A computer program product comprising a non-transitory computer-readable memory having program instructions embodied therewith, the program instructions executable by a processor to cause the processor to:
map, by the processor, a data graph to a lattice structure of a quantum computer, wherein the mapping comprises:
mapping a graph node of the data graph to a lattice node of the lattice structure; and
mapping the immediate descendant nodes and grand-descendant nodes of the graph node to nodes of the lattice structure based on relative number of edges of the immediate descendant nodes and grand-descendant nodes and the nodes of the lattice structure.

15. The computer program product of claim 14, wherein the program instructions are further executable by the processor to cause the processor to:
compute, by the processor, number of edges of nodes in in the data graph;
compute, by the processor, number of edges of nodes in the lattice structure;
executing a breadth first search starting from the lattice node;
executing a depth first search starting from the graph node; and
sorting immediate descendant nodes of the graph node by number of edges.

16. The computer program product of claim 15, wherein the program instructions are further executable by the processor to cause the processor to:
select, by the processor, the graph node from the data graph based on number of edges of nodes in the data graph.

17. The computer program product of claim 16, wherein the program instructions are further executable by the processor to cause the processor to:
select, by the processor, the lattice node from the lattice structure based on number of edges of nodes in the lattice structure.

18. The computer program product of claim 14, wherein the mapping further comprises, repeating, by the processor, the mapping starting from mapped immediate descendant nodes and grand-descendant nodes of the graph node.

19. The computer program product of claim 14, wherein the lattice structure comprises a heavy-hex structure.

20. The computer program product of claim 17, wherein the lattice node is further selected based on relative closest position to a center of the lattice structure.
